(19) United States
(12) Patent Application Publication
(10) Pub. No.: US 2004/0117504 A1
(43) Pub. Date: Jun. 17, 2004

(54) Communication channel

(76) Inventors: Klaus I. Pedersen, Aalborg (DK); Jeroen Wigard, Aalborg (DK); Preben Mogensen, Gistrup (DK); Troels E. Kolding, Klarup (DK)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/317,204

(22) Filed: Dec. 12, 2002

(51) Int. Cl. G06F 15/173

(52) U.S. Cl. 709/238

(57) ABSTRACT

There is disclosed a data scheduler for a communication system adapted to transmit traffic to a user, comprising means for selectively simultaneously transmitting traffic to the user on a dedicated user channel and on a shared user channel. The data scheduler comprises means adapted to monitor the level of offered traffic in the dedicated channel relative to a predetermined threshold level; and means responsive to the traffic level in the dedicated channel exceeding a predetermined threshold level for limiting the traffic on the dedicated channel and assigning traffic to a shared user channel. A method of assigning traffic is also disclosed.

### BACKGROUND OF THE INVENTION

1. Field of the Invention

The present invention is related to allocating traffic to channels in the down link of a communication system, and particularly but not exclusively to a UMTS mobile communication system.

2. Description of the Related Art

In a UMTS (universal mobile telecommunication system) there is provided a downlink shared channel (DSCH) which is shared between multiple user equipment (UE). Typically data on the DSCH is time multiplexed, with each user being associated with a particular time slot. The DSCH is transmitted on the physical downlink shared channel (PDSCH).

All UEs which can receive data on the DSCH also have a dedicated channel (DCH) for receiving data in the downlink. The DCH is power-controlled, and carries control information to a UE. Such control information includes an indication of the location in the DSCH of data for that UE. In addition, the DCH may carry data for the UE. The DCH is transmitted on the dedicated physical channel (DPCH).

The transmit power of the PDSCH in a given time-slot is equal to the transmit power of the associated DPCH, plus a fixed power offset. Hence, both the PDSCH and the DPCH are power-controlled.

In current specifications, it is stated that it is desirable to use the DSCH for the transmission of bursty packet traffic with high peak data rates for multiple UEs. In this scenario, the DSCH is more code efficient than the DCH. In this context, code efficiency refers to utilisation of the channelisation codes, which are used for separation of physical channels within a cell. The DSCH also offers possibilities for implementation of faster and more flexible packet scheduling mechanisms compared to traffic carried by DCHs. This may be translated to an improved quality of service (QoS).

However, operation of the DSCH at high data rates may lead to severe problems due to the fast power control requirements. In order to facilitate high data rates on the DSCH a high power level is required. Assignment of high power levels, for example above 5 Watts (for a Node-B with 20 Watts maximum power), may therefore create severe problems when fast power control is required. Basically, a high power control head-room is required, which is equivalent to lost capacity. This implies that it is difficult to obtain the theoretical maximum capacity gain from using the DSCH to carry all the bursty packet traffic.

It is an object of the present invention to provide an improved technique for transporting traffic in the downlink of a communication system.

### SUMMARY OF THE INVENTION

In accordance with the present invention there is provided a method of assigning traffic in the downlink of a communication system, comprising: selectively simultaneously assigning traffic for a user to a dedicated user channel and to a shared user channel.

The method may further comprise the step of monitoring the level of traffic in the dedicated channel; and responsive to the offered traffic level in the dedicated channel exceeding a predetermined threshold level, limiting the traffic on the dedicated channel and assigning traffic to a shared user channel. The traffic on the dedicated channel may be limited to the threshold level, and offered traffic above the threshold level is assigned to the shared user channel.

The dedicated user channel may be power-controlled. The shared user channel may be time-multiplexed. The time-slots of the shared user channel may be power-controlled in dependence on the power requirements of a user associated with such time-slot. Traffic may be allocated to a plurality of dedicated user channels for a plurality of users, and selectively simultaneously assigned to the shared channel for at least one user. The traffic may be data traffic.

The method may be implemented in a UMTS system, wherein the dedicated user channels are transmitted on respective dedicated physical channels, and the shared user channel is transmitted on a physical downlink shared channel.

According to a further aspect of the present invention there is provided a data scheduler for a communication system adapted to transmit traffic to a user, comprising means for selectively simultaneously transmitting traffic to the user on a dedicated user channel and on a shared user channel.

The data scheduler may comprise means adapted to monitor the level of offered traffic in the dedicated channel relative to a predetermined threshold level; and means responsive to the traffic level in the dedicated channel exceeding a predetermined threshold level for limiting the traffic on the dedicated channel and assigning traffic to a shared user channel.

The means may be adapted to limit traffic on the dedicated channel to the threshold level, and assign traffic above the threshold level to the shared user channel. The data scheduler may comprise means for controlling the power level of the dedicated user channel.

The shared user channel may be time-multiplexed. The time-slots of the shared user channel may be power-controlled in dependence on the power requirements of a user associated with such time-slot.

The means for allocating traffic may be adapted to allocate traffic to a plurality of dedicated user channels for a plurality of users, and selectively simultaneously assign traffic to the shared channel for at least one user. The traffic may be data traffic.

In a UMTS the dedicated user channels may be transmitted on respective dedicated physical channels, and the shared user channel may be transmitted on a physical downlink shared channel.

### BRIEF DESCRIPTION OF THE DRAWINGS

The invention will now be described by way of example with reference to the accompanying drawings in which:

FIG. 1 illustrates an example scenario of a communication system within which context the present invention is described;

FIG. 2 illustrates the downlink channels in a preferred implementation of the present invention;

FIG. 3 illustrates the method steps in implementing a preferred embodiment of the invention;

FIG. 4 illustrates an example implementation of a packet scheduler in accordance with the present invention; and

FIG. 5 illustrates an example of data traffic levels and channel allocation in accordance with the preferred embodiment of the present invention.

### DESCRIPTION OF PREFERRED EMBODIMENTS

The present invention is described herein by way of reference to a particular example, and particularly to a UMTS system. One skilled in the art will appreciate from the following description that the invention is not limited to such a system.

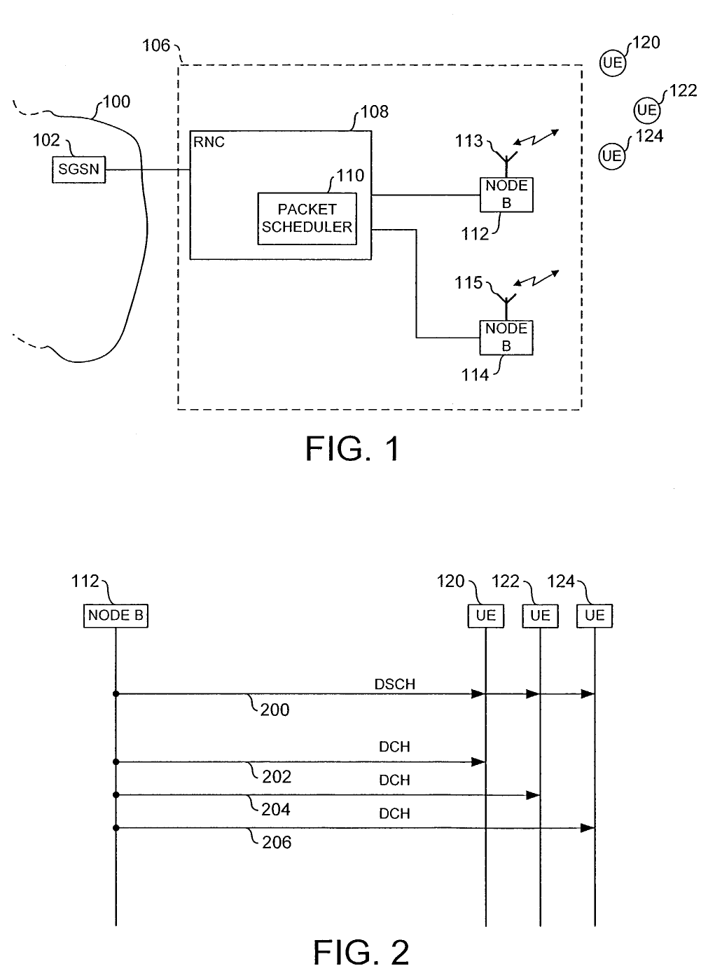

Referring to FIG. 1, there is illustrated some of the main elements of a UMTS system. FIG. 1 does not illustrate a full implementation of such a system, which implementation will be apparent to on skilled in the art. Rather FIG. 1 illustrates the basic elements of such a system necessary for placing the present invention into context.

Referring to FIG. 1, there is generally illustrated a UMTS radio access network (UTRAN) generally designated by reference numeral 106. The UTRAN 106 includes a radio access controller (RNC)108, including a packet scheduler 110. The UTRAN 106 further includes a node-B (base transceiver station) 112 and associated antenna 113, which is connected to the RNC 108 and supports communication in the air interface to three UEs 120, 122, and 124. The RNC supports further Node-Bs, such as node-B 114 and associated antenna 115. On the network side, the UTRAN 106 is further connected to a core network 100, including a serving GPRS support node (SGSN) 102.

Turning to FIG. 2, there is illustrated the provision of channels in the downlink necessary for the implementation of the invention in the embodiment of FIG. 1. As shown in FIG. 2, there is provided a downlink shared channel (DSCH) 200 on which the Node B 112 can transport traffic to each of the UEs 120, 122, 124. There is provided a dedicated channel (DCH) 202 on which the node-B 112 can transport traffic to the UE 120. There is provided a dedicated channel (DCH) 204 on which the node-B 112 can transport traffic to the UE 122. There is provided a dedicated channel (DCH) 206 on which the node-B 112 can transport traffic to the UE 124.

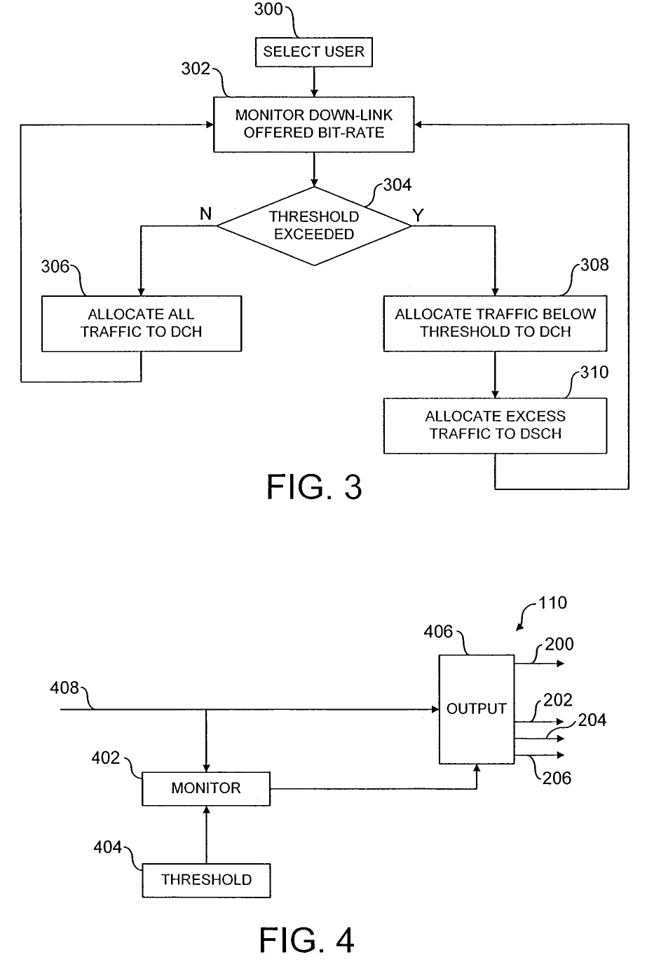

The principle of use of the downlink channels in FIG. 2 in accordance with the present invention is now described by way of reference the flow chart of FIG. 3. At the start of traffic transmission, in a step 300 a user to which the traffic is to be transmitted is selected. In a step 302, the downlink traffic throughput requirements for that user are monitored.

A threshold value for the traffic throughput for each UE is predetermined and stored in the packet scheduler. The predetermined value may be implementation specific. The value may be different for different users. The value may change for different packet transmissions.

In a step 304, the offered traffic level, in the preferred embodiment the offered bit-rate, for a UE is compared to the predetermined threshold value for that UE.

If the offered bit-rate does not exceed the threshold, then in a step 306 the traffic is all allocated to the DCH for the UE.

If the offered bit-rate does exceed the threshold, then in a step 308 a traffic volume below the threshold is allocated the DCH, and then in a step 310 the remaining traffic, or excess traffic, is allocated to the DSCH.

Thus, during peak traffic periods when the offered bit-rate exceeds the threshold, and thereby the capacity of the associated DCH, the traffic stream is split between the DSCH and the associated DCH for the UE. Hence, the DSCH carries the additional peak traffic which the DCH cannot handle.

The throughput threshold, used for deciding the whether part of the data stream is allocated to the shared channel, is preferably set independently for each user. The threshold is preferably a function of the data rate support on the dedicated channel allocated to each user.

The traffic is preferably data traffic.

Preferably the control of traffic in accordance with the present invention is implemented in the packet scheduler. Although in the described embodiment of the invention the packet scheduler is implemented in the UTRAN in the RNC, in other embodiments it may be located elsewhere. For example, the packet scheduler maybe implemented in the IP (Internet protocol) RAN (radio access network) (WCDMA—wideband code division multiple access) in an IP BTS (base transceiver station).

For completeness, an example implementation of the packet scheduler 110 of FIG. 1 in accordance with an embodiment of the invention is described with relation to FIG. 4. A traffic flow to be transmitted on the downlink to a UE is presented on line 408. The traffic is monitored by a monitor block 402 which compares the current offered bit-rate to a threshold value stored in a block 404. The output block 406 outputs the traffic on line 408 to the appropriate one of the dedicated channels 202,204,206. In accordance with the present invention the output block is responsive to a control signal from the monitor block 402 to selectively transmit traffic on the shared channel 200.

The present invention offers several technical advantages, including:

The high utilisation of the dedicated channel for a UE. Consequently the associated dedicated channel is not an overhead to the DSCH. This is equivalent to higher code efficiency.

Support of peaky traffic streams with marginal peak data rates on the DSCH (i.e. the traffic is split between the associated DCH and PDSCH during peak periods.

Improved QoS during peak periods with non-peaky traffic, i.e. the full traffic is carried by the associated DCH, which basically means minimal delay. If the traffic is carried by the DSCH only, then traffic to some UEs is subject to potentially long delays, due to the time-multiplexing mechanism applied for user separation.

As such, the required data rates on the DSCH are reduced compared to the case where the traffic stream is carried only by the DSCH. This results in much lower transmit power levels of the DSCH, which again means that a large power control headroom is not needed.

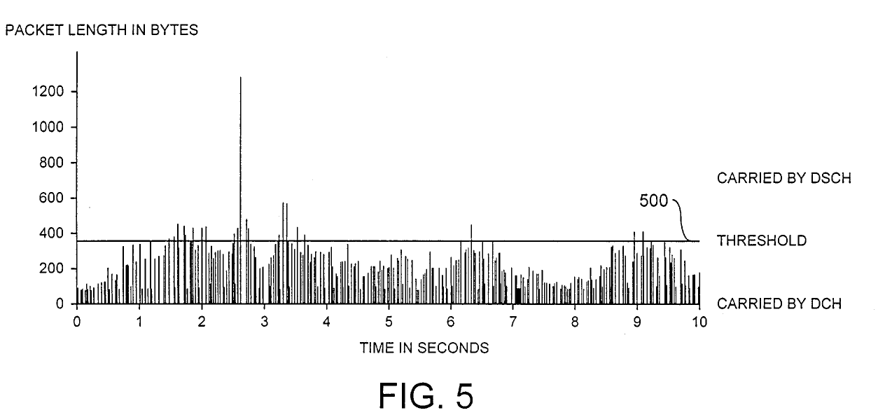

Finally, FIG. 5 illustrates the throughput versus time of a traffic flow for a UE. As can be seen, a threshold level 500 is provided. Traffic above the threshold level is carried by the DSCH. Traffic below the threshold level is carried by the DCH.

The present invention has been described herein by way of reference to particular non-limiting examples. One skilled in the art will appreciate the broader applicability of the present invention. The scope of protection afforded is defined by the appended claims.

1. A method of assigning traffic in the downlink of a communication system, comprising: selectively simultaneously assigning traffic for a user to a dedicated user channel and to a shared user channel.

2. A method according to claim 1, further comprising:
monitoring the level of traffic in the dedicated channel; and
limiting the traffic on the dedicated channel and assigning traffic to a shared user channel, responsive to the offered traffic level in the dedicated channel exceeding a predetermined threshold level.

3. A method according to claim 2, wherein the traffic on the dedicated channel is limited to the threshold level, and offered traffic above the threshold level is assigned to the shared user channel.

4. A method according to claim 1, wherein the dedicated user channel is power-controlled.

5. A method according to claim 1, wherein the shared user channel is time-multiplexed.

6. A method according to claim 5, wherein time-slots of the shared user channel are power-controlled in dependence on the power requirements of a user associated with a time-slot.

7. A method according to claim 1, wherein traffic is allocated to a plurality of dedicated user channels for a plurality of users, and selectively simultaneously assigned to the shared channel for at least one user.

8. A method according to claim 1, wherein the traffic comprises data traffic.

9. A method according to claim 1, wherein a plurality of dedicated user channels are transmitted on respective dedicated physical channels, and the shared user channel is transmitted on a physical downlink shared channel, and wherein the method is performed in a UMTS system.

10. A data scheduler for a communication system adapted to transmit traffic to a user, said data scheduler comprising:
first means for selectively simultaneously transmitting traffic to the user on a dedicated user channel and on a shared user channel.

11. A data scheduler according to claim 10, further comprising:
second means adapted to monitor a level of offered traffic in the dedicated user channel relative to a predetermined threshold level; and
third means responsive to the traffic level in the dedicated channel exceeding a predetermined threshold level for limiting traffic on the dedicated channel and assigning traffic to a shared user channel.

12. A data scheduler according to claim 11, wherein said third means limits traffic on the dedicated channel to the threshold level, and assigns traffic above the threshold level to the shared user channel.

13. A data scheduler according to claim 10, further comprising second means for controlling a power level of the dedicated user channel.

14. A data scheduler according to claim 10, wherein the shared user channel is time-multiplexed.

15. A data scheduler according to claim 14, wherein time-slots of the shared user channel are power-controlled in dependence on power requirements of a user associated with a time-slot.

16. A data scheduler according to claim 10, wherein the first means is adapted to allocate traffic to a plurality of dedicated user channels for a plurality of users, and selectively simultaneously assign traffic to the shared channel for at least one user.

17. A data scheduler according to claim 10, wherein the traffic comprises data traffic.

18. A data scheduler according to claim 10, wherein the dedicated user channels are transmitted on respective dedicated physical channels, and the shared user channel is transmitted on a physical downlink shared channel, and wherein the data scheduler is part of a UMTS.
